(19) United States
(12) Patent Application Publication
(10) Pub. No.: US 2021/0381453 A1
(43) Pub. Date: Dec. 9, 2021

(54) EVAPORATED FUEL TREATMENT APPARATUS

(71) Applicant: AISAN KOGYO KABUSHIKI KAISHA, Obu-shi, Aichi-ken (JP)

(72) Inventor: Makoto NAKAGAWA, Nagoya-shi (JP)

(73) Assignee: AISAN KOGYO KABUSHIKI KAISHA, Obu-shi, Aichi-ken (JP)

(21) Appl. No.: 17/288,096

(22) PCT Filed: Sep. 5, 2019
(86) PCT No.: PCT/JP2019/034983

§ 371 Date: Apr. 23, 2021

(30) Foreign Application Priority Data
Nov. 20, 2018 (JP) 2018-217433

(51) Int. Cl. F02D 41/00; F02M 25/08

(52) U.S. Cl. CPC F02D 41/0045; F02M 25/0836

(57) ABSTRACT

An evaporated fuel treatment apparatus is provided with a purge pump and a purge valve and an electronic control unit (ECU) for controlling the purge pump and the purge valve. The ECU, when performing purging, opens the purge valve to control the purge pump at the rated rotational speed, and when stopping purging, closes the purge valve to control the purge pump at a zero rotational speed. When starting purging, the ECU gradually controls the purge pump from a rotational speed lower than the rated rotational speed toward the rated rotational speed before opening the purge valve which is in the closed state, and opens the purge valve when the purge pump reaches a first threshold rotational speed lower than the rated rotational speed during the performing the control.

### TECHNICAL FIELD

The technique disclosed in this specification relates to an evaporated fuel treatment apparatus for processing evaporated fuel generated in a fuel tank.

### BACKGROUND ART

Heretofore, as this type of technique, an “evaporated fuel treatment apparatus” described in Patent Document 1 listed below has been known, for example. This apparatus is provided with a canister to collect evaporated fuel (vapor) generated in a fuel tank, a purge passage to introduce the vapor collected in the canister to an intake passage of an engine, a purge valve to open and close the purge passage, a purge pump provided in the purge passage to pressure-feed (pump) the vapor collected in the canister to the intake passage, and an electronic control unit (ECU) to control the purge valve, the purge pump, and others. The ECU defines (sets) a predetermined condition (purge condition) of opening the purge valve and operating the purge pump to carry out purge processing during operation of the engine and defines a predetermined condition (precondition) which is established during operation of the engine and before establishment of the purge condition. Then, the ECU is configured to start operation of the purge pump when the precondition is established and to open the purge valve when the purge pump reaches a predetermined rated rotational speed and the purge condition is established. Accordingly, when the purge condition of opening the purge valve is established, the time required for the purge pump to reach the rated rotational speed is made shorter and shortage of a purge flow rate due to response delay in purging is prevented.

This evaporated fuel treatment apparatus may be, for example, mounted on a hybrid vehicle of a series hybrid vehicle system. The hybrid vehicle of the series hybrid vehicle system uses an engine only for power generation, uses a motor only for driving of a shaft and regeneration of the shaft, and includes a storage battery for collecting the electric power. This type of hybrid vehicle may be interpreted as an electric vehicle mounted with an engine as a power source for electricity generation. Herein, even though there is no explicit indication in the Patent Document 1, the hybrid vehicle of the series hybrid vehicle system is arranged to perform steady driving of the engine based on a charged state of the storage battery, a fuel consumption amount of the engine, and others. During steady driving of the engine, there is no need for the evaporated fuel treatment apparatus to control purging finely or with good responsivity.

### RELATED ART DOCUMENTS

### Patent Documents

Patent Document 1: JP2017-067008A

### SUMMARY OF INVENTION

### Problems to be Solved by the Invention

Incidentally, nowadays, there is a tendency of increase in size of a purge pump by the request of increase in a purge flow rate, and further, operation of the purge pump needs to be started earlier in order to improve the responsivity of purging. Herein, as described in the technique of the Patent Document 1, in order to start operation of the purge pump from a valve-closed state of the purge valve and to maintain the valve-closed state until the purge pump reaches the rated rotational speed (in order to shut off purging of the vapor), there needs to set a large shut-off force of the purge valve and to set a large force of opening the purge valve from the valve-closed state. In response to those necessity, there needs to increase the force of the spring urging a valve element of the purge valve in a direction to make the valve element seated on a valve seat, to enlarge a member (a solenoid, for example) that is to electrically drive the valve element, and to increase a supply power to the solenoid. As a result of this, manufacturing cost for the purge valve and energy required for operation of the purge valve could be increased.

The present disclosure has been made in view of the above circumstances and has a purpose of providing an evaporated fuel treatment apparatus that can set a shut-off force of a purge valve or a force of opening the purge valve from a valve-closed state to be small and can reduce manufacturing cost for the purge valve and energy required for operation of the purge valve.

### Means of Solving the Problems

(1) To achieve the above purpose, one embodiment of the present disclosure provides an evaporated fuel treatment apparatus comprising: a canister to collect evaporated fuel generated in a fuel tank; a purge passage to introduce and purge the evaporated fuel collected in the canister to an intake passage of an engine; a purge pump provided in the purge passage to pressure-feed the evaporated fuel collected in the canister to the intake passage, the purge pump being configured to control a discharge pressure of the evaporated fuel according to a rotational speed of the purge pump; a purge valve provided in the purge passage downstream of the purge pump to open and close the purge passage; and a control member to control the purge pump and the purge valve, the control member being configured to control the purge valve to open and the purge pump to be a predetermined rated rotational speed when the evaporated fuel is purged from the canister to the intake passage and to control the purge valve to close and the purge pump to be a rotational speed of zero when purging of the evaporated fuel is to be halted, wherein, when starting purging the evaporated fuel, the control member gradually controls the purge pump from a rotational speed lower than the rated rotational speed to the rated rotational speed before opening the purge valve from a valve-closed state and opens the purge valve in a process of the control when the purge pump has reached a predetermined first threshold rotational speed that is lower than the rated rotational speed.

According to the above configuration (1), when the evaporated fuel is to be purged from the canister to the intake passage, the control member controls the purge valve to open and the purge pump to be the predetermined rated rotational speed, and when purging is to be halted, the control member controls the purge valve to close and the purge pump to be the rotational speed of zero. Herein, when the evaporated fuel starts to be purged, the control member gradually controls the purge pump to be the rated rotational speed from the rotational speed lower than the rated rotational speed before opening the purge valve from the valve-closed state, and during the control process, the control member controls the purge valve to be opened when the purge pump has reached the predetermined first threshold rotational speed that is lower than the rated rotational speed. Accordingly, in the process of gradually controlling the purge pump toward the rated rotational speed, the purge valve is opened when the purge pump has reached the first threshold rotational speed lower than the rated rotational speed, so that the shut-off force of the purge valve or the force of opening the purge valve from the valve-closed state can be restrained to a force enough to oppose to a pressure lower than a discharge pressure of the purge pump that has reached the rated rotational speed.

(2) To achieve the above purpose, in the above configuration (1), preferably, when purging of the evaporated fuel is to be halted, the control member gradually controls the purge pump to be the rotational speed of zero from the rated rotational speed before closing the purge valve from a valve-open state and to close the purge valve when the purge pump has reached a predetermined second threshold rotational speed that is lower than the rated rotational speed in the process of the control.

According to the above configuration (2), in addition to the operation of the above configuration (1), when purging of the evaporated fuel is to be halted, the control member gradually controls the purge pump to be the rotational speed of zero from the rated rotational speed before closing the purge valve from the valve-open state, and during the control process, the control member controls the purge valve to close when the purge pump has reached the predetermined second threshold rotational speed that is lower than the rated rotational speed. Accordingly, in the process of gradually controlling the purge pump to be the zero rotational speed from the rated rotational speed, the purge valve is closed when the purge pump has reached the second threshold rotational speed that is lower than the rated rotational speed, and thus it is possible to restrain the force of closing the purge valve from the valve-open state to be low enough to oppose to a pressure lower than the discharge pressure of the purge pump that has reached the rated rotational speed.

(3) To achieve the above purpose, in the above configuration (2), preferably, the purge valve includes: a passage in which the evaporated fuel flows; a valve seat provided in the passage; a valve element provided upstream of the valve seat and allowed to be seated on the valve seat; a spring to urge the valve element in a direction to be seated on the valve seat; and a driving member to drive the valve element, and the second threshold rotational speed is set higher than the first threshold rotational speed.

According to the above configuration (3), in addition to the operation of the above configuration (2), the purge valve is a type of providing the valve element upstream of the valve seat to be seated on the valve seat. In this type of the purge valve, in the valve-closed state in which the valve element is seated on the valve seat, both the pressure of the evaporated fuel and the urging force of the spring are applied to the valve element in the direction to be seated on the valve seat. Accordingly, when the purge valve is to be opened, the valve element is driven by the driving member to be separated away from the valve seat at the time when the purge pump has reached the first threshold rotational speed that is lower than the rated rotational speed, and thus the driving force of the driving member required for valve opening becomes relatively small. Further, the second threshold rotational speed related to valve closing of the purge valve is set higher than the first threshold rotational speed related to valve opening, so that the driving member can be operated earlier by that difference of the threshold rotational speed when the purge valve is to be closed.

(4) To achieve the above purpose, in the above configuration (2), preferably, the purge valve includes: a passage in which the evaporated fuel flows; a valve seat provided in the passage; a valve element provided downstream of the valve seat and allowed to be seated on the valve seat; a spring to urge the valve element in a direction to be seated on the valve seat; and a driving member to drive the valve element, and the second threshold rotational speed is set equal to the first threshold rotational speed.

According to the above configuration (4), in addition to the operation of the above configuration (2), the purge valve is a type of providing the valve element downstream of the valve seat to be seated on the valve seat. In this type of the purge valve, in the valve-closed state in which the valve element is seated on the valve seat, only the urging force of the spring is applied to the valve element to be seated on the valve seat while the pressure of the evaporated fuel is applied to the valve element in a direction to separate the valve element from the valve seat. Accordingly, when the purge valve is to be opened, the valve element is driven by the driving member to be separated from the valve seat when the purge pump has reached the first threshold rotational speed that is lower than the rated rotational speed, and thus the urging force of the spring, which has urged the valve element to be seated on the valve seat against the pressure of the evaporated fuel, can be set relatively small. Further, the spring has less aging effects than the driving force of the driving member, and thus the purge valve is prevented from opening at unintentional timing and prevented from being kept its valve open state.

(5) To achieve the above purpose, in any one of the above configurations (1) to (4), preferably, the evaporated fuel treatment apparatus further comprises a member of detecting a concentration of the evaporated fuel and a member of detecting a temperature of the evaporated fuel, and the control member is configured to correct at least any one of the first threshold rotational speed and the second threshold rotational speed based on a detected concentration and a detected temperature of the evaporated fuel.

According to the above configuration (5), in addition to the operation of any one of the above configurations (1) to (4), at least any one of the first threshold rotational speed and the second threshold rotational speed is corrected based on the detected concentration and temperature of the evaporated fuel, and thus at least any one of the first threshold rotational speed and the second threshold rotational speed can be preferably corrected according to the properties of the evaporated fuel.

(6) To achieve the above purpose, in any one of the above configurations (1) to (5), preferably, when starting purging of the evaporated fuel, during a request of purging start being made, the control member gradually controls the purge pump to the rated rotational speed from the rotational speed lower than the rated rotational speed to the rated rotational speed before opening the purge valve from the valve-closed state and during the purge pump having reached the first threshold rotational speed in the process of the control, the control member opens the purge valve.

According to the above configuration (6), in addition to the operation of any one of the above configurations (1) to (5), the purge pump is gradually controlled to be the rated rotational speed upon receipt of the purging start request, and when the purge pump has reached the first threshold rotational speed in the control process, the purge valve is opened. Accordingly, irrespective of establishment of any purging preconditions, by the time when the purge pump has reached the rated rotational speed, the necessary and sufficient evaporated fuel is to be purged to the intake passage.

(7) To achieve the above purpose, in any one of the above configurations (1) to (5), preferably, when starting purging of the evaporated fuel, during a predetermined purging precondition being established and before opening the purge valve from the valve-closed state, the control member gradually controls the purge pump to the rated rotational speed from the rotational speed lower than the rated rotational speed before opening the purge valve from the valve-closed state and during the purge pump having reached the first threshold rotational speed and a request of purging start being made in the process of the control, the control member opens the purge valve.

According to the above configuration (7), in addition to the operation of any one of the above configurations (1) to (5), when the purging precondition is established, the purge pump is gradually controlled to the rated rotational speed, and when the purge pump has reached the first threshold rotational speed and the purging start is requested in the control process, the purge valve is opened. Accordingly, as long as the purging precondition is established, the gradual control of the purge pump is started even if there is no request of purging start, and thus when the purging start is requested, the purge valve is opened and the evaporated fuel can be purged to the intake passage in early stage.

### Effects of the Invention

According to the above configuration (1), the purge valve can be set with a relatively small shut-off force or a relatively small force of opening the purge valve from the valve-closed state, so that reduction in the manufacturing cost for the purge valve and reduction in the energy required for operation of the purge valve can be achieved.

According to the above configuration (2), in addition to the effect of the above configuration (1), the purge valve can be set with a relatively small force of closing the purge valve from the valve-open state, so that reduction in the manufacturing cost for the purge valve and reduction in the energy required for operation of the purge valve can be achieved.

According to the above configuration (3), in addition to the effect of the above configuration (2), the energy required for operation of the purge valve can further be reduced.

According to the above configuration (4), in addition to the effect of the above configuration (2), valve-opening of the purge valve can be accurately controlled.

According to the above configuration (5), in addition to the effect of any one of the above configurations (1) to (4), timing of opening and closing the purge valve can be accurately controlled according to the properties of the evaporated fuel.

According to the above configuration (6), in addition to the effect of any one of the above configurations (1) to (5), irrespective of establishment of the purging precondition, the evaporated fuel can be appropriately purged to the intake passage.

According to the above configuration (7), in addition to the effect of any one of the above configurations (1) to (5), the responsivity of purging with respect to the purging start request can be improved.

### BRIEF DESCRIPTION OF THE DRAWINGS

FIG. 1 is a schematic view of an engine system including an evaporated fuel treatment apparatus mounted on a hybrid vehicle in a first embodiment;

FIG. 2 is a sectional view showing one example of a purge valve in the first embodiment;

FIG. 3 is a flowchart indicating contents of purge control in the first embodiment;

FIG. 4 is a first correction coefficient map referred to calculate a first correction coefficient with respect to a vapor concentration and a vapor temperature in the first embodiment;

FIG. 5 is a second correction coefficient map referred to calculate a second correction coefficient with respect to the vapor concentration and the vapor temperature in the first embodiment;

FIG. 6 is a time chart illustrating one example of behavior of various parameters in the purge control in the first embodiment;

FIG. 7 is a time chart illustrating one example of behavior of various parameters (especially, an upstream and downstream pressure difference of the purge valve) in the purge control in the first embodiment;

FIG. 8 is a flowchart indicating contents of purge control in a second embodiment;

FIG. 9 is a flowchart indicating contents of the purge control in the second embodiment;

FIG. 10 is a sectional view of one example of the purge valve in a third embodiment; and

FIG. 11 is a time chart illustrating one example of behavior of various parameters (especially, an upstream and downstream pressure difference of the purge valve) in purge control in the third embodiment.

### MODE FOR CARRYING OUT THE INVENTION

### First Embodiment

A detailed description of a first embodiment embodying an evaporated fuel treatment apparatus will now be given with reference to the accompanying drawings.

(Outline of Engine System)

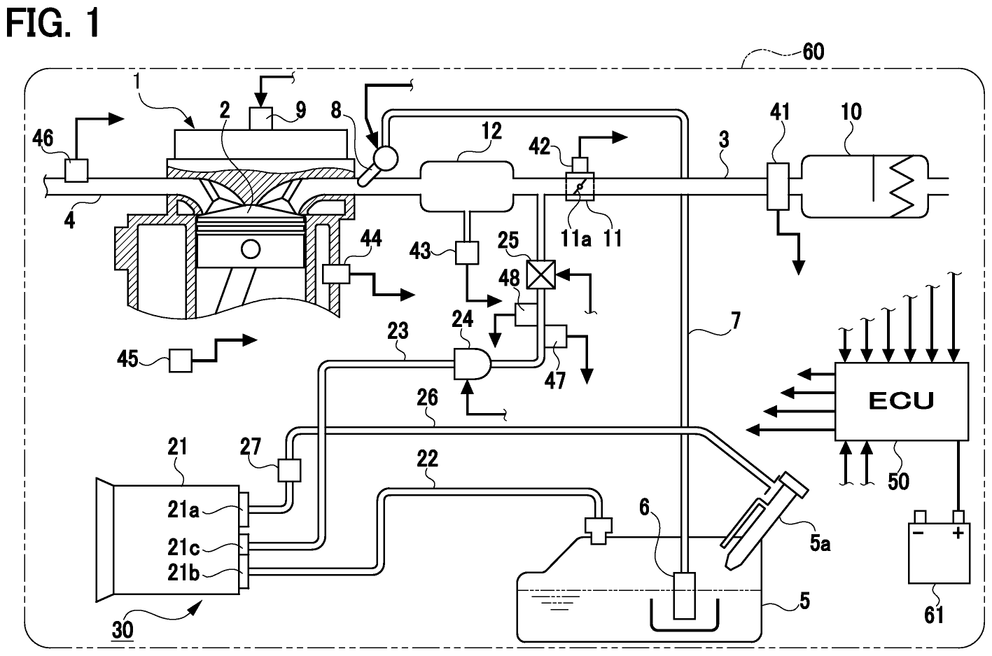

FIG. 1 is a schematic view of an engine system including an evaporated fuel treatment apparatus 30 mounted on a hybrid vehicle 60. In this embodiment, the hybrid vehicle 60 of a series hybrid configuration is adopted. The hybrid vehicle 60 of the series hybrid configuration uses, as well-known, an engine 1 only for power generation, uses a motor (not shown) only for driving of an axle and regeneration of the axle, and includes a storage battery 61 for collecting electric power. The engine 1 is provided with an intake passage 3 to intake the air and others into a combustion chamber 2 and an exhaust passage 4 to discharge exhaust air from the combustion chamber 2. To the combustion chamber 2, a fuel stored in a fuel tank 5 is to be supplied. Specifically, the fuel in the fuel tank 5 is discharged out to a fuel passage 7 by a fuel pump 6 that is embedded in the tank 5, and then pressure-fed to an injector 8 provided in an intake port of the engine 1. The thus pressure-fed fuel is injected from the injector 8 and introduced in the combustion chamber 2 with the air flowing in the intake passage 3 to form combustible air-fuel mixture that is used for combustion. The engine 1 is provided with an ignition device 9 for igniting the combustible air-fuel mixture.

The intake passage 3 is provided from its inlet side to the engine 1 with an air cleaner 10, a throttle device 11, and a surge tank 12 in this order. The throttle device 11 includes a throttle valve 11a to be opened and closed to adjust an intake flow amount of the intake air flowing in the intake passage 3. Opening and closing of the throttle valve 11a is associated with operation of an accelerator pedal (not shown) by a driver. The surge tank 12 is to smoothen intake air pulsation in the intake passage 3.

(Configuration of Evaporated Fuel Treatment Apparatus)

In FIG. 1, an evaporated fuel treatment apparatus 30 of the present embodiment is configured to process the evaporated fuel (vapor) generated in the fuel tank 5 without discharging outside in the atmosphere. This apparatus 30 is provided with a canister 21 to collect the vapor generated in the fuel tank 5, a vapor passage 22 to introduce the vapor from the fuel tank 5 to the canister 21, a purge passage 23 to purge the vapor collected in the canister 21 to the intake passage 3, a purge pump 24 to pressure-feed the vapor collected in the canister 21 to the intake passage 3, and a purge valve 25 provided in the purge passage 23 downstream of the purge pump 24 to open and close the purge passage 23.

The canister 21 is internally provided with an absorbent such as activated charcoal. The canister 21 includes an atmospheric port 21a to introduce the atmosphere, an inflow port 21b to introduce the vapor, and an outflow port 21c to bring out the vapor. An internal space of the canister 21 is communicated with the atmosphere. Namely, a leading end of an atmospheric passage 26 extending from the atmospheric port 21a is communicated with an inlet of a fuel-feeding cylinder 5a of the fuel tank 5. This atmospheric passage 26 is provided with a filter 27 to capture mine dust and others in the air. A leading end of the vapor passage 22 extending from the inflow port 21b of the canister 21 is communicated with an inside of the fuel tank 5. A leading end of the purge passage 23 extending from the outflow port 21c of the canister 21 is communicated with the intake passage 3 between the throttle device 11 and the surge tank 12.

In the present embodiment, the purge pump 24 is constituted by an electrically-operated centrifugal pump including a motor (not shown) and is configured to be controlled its discharge pressure in accordance with a rotational speed of the motor.

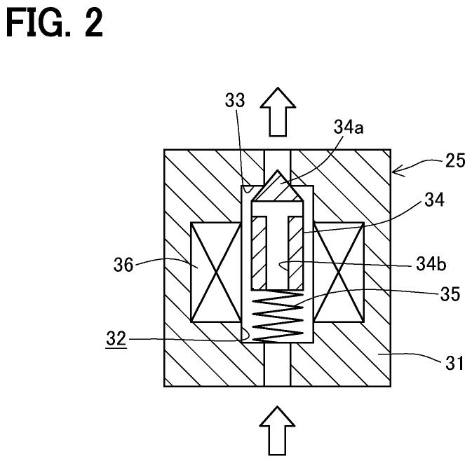

In the present embodiment, the purge valve 25 is constituted by a normally-closed electromagnetic open-close valve (shut-off valve) and allowed to be opened and closed to release or shut off the purge passage 23. FIG. 2 shows one example of a sectional view of the purge valve 25. As shown in FIG. 2, this purge valve 25 includes a housing 31, a passage 32 formed in the housing 31 to make the vapor flow, a valve seat 33 provided in the passage 32, a valve element 34 provided upstream of the valve seat 33 to be seated on the valve seat 33, a spring 35 to urge the valve element 34 in a direction to be seated on the valve seat 33, and a solenoid 36 to drive the valve element 34 by the magnetic force. In a state shown in FIG. 2, a lower side of the passage 32 indicates an upstream side of vapor flow, and an upper side of the passage 32 indicates a downstream side of the vapor flow. The valve element 34 is of a columnar shape provided on its leading end with a conical portion 34a, and is formed inside with a hole 34b allowing the vapor to flow.

This purge valve 25 is urged in a direction to make the valve element 34 seat on the valve seat 33 by the spring 35 while the solenoid 36 is not excited (off), and thus the valve is closed as shown in FIG. 2. On the other hand, the purge valve 25 is opened by excitation of the solenoid 36 from the valve-closed state shown in FIG. 2 to move the valve element 34 downward against the urging force of the spring 35. In this purge valve 25, the valve element 34 is applied with the pressure of the vapor from the upstream side of the passage 32, and thus during operation of the purge pump 24, both the pressure of the vapor and the urging force of the spring 35 are applied to the valve element 34 in a direction to make the valve element 34 seat on the valve seat 33 (valve closing). Further, when the purge pump 24 is out of operation, only the urging force of the spring 35 is applied in a direction to make the valve element 34 seat on the valve seat 33 (valve closing). Accordingly, there needs to generate an electromagnetic force in the solenoid 36 which is large enough to overpower a resultant force of the vapor pressure and the urging force of the spring 35 in order to open the purge valve 25 during operation of the purge pump 24. The solenoid 36 corresponds to one example of a driving member of the present disclosure.

The above-configured evaporated fuel treatment apparatus 30 introduces the vapor generated in the fuel tank 5 to the canister 21 via the purge passage 22 and once collects the vapor in the canister 21. Then, the purge pump 24 is operated and the purge valve 25 is operated (valve opening) during operation of the engine 1. Thus, the vapor collected in the canister 21 is pressure-fed to the intake passage 3 from the canister 21 via the purge passage 23. This vapor flow rate can be adjusted by controlling the rotational speed of the purge pump 24.

(Electrical Configuration of Engine System)

In the present embodiment, various sensors and others 41 to 46 to detect the operation state of the engine 1 are provided. An air flow meter 41 provided in a vicinity of the air cleaner 10 detects an air amount sucked in the intake passage 3 as an intake air amount and outputs an electric signal corresponding to a detected value. A throttle sensor 42 provided in the throttle device 11 detects an open degree of the throttle valve 11 as a throttle open degree and outputs an electric signal corresponding to a detected value. An intake pressure sensor 43 provided in the surge tank 12 detects a pressure inside the surge tank 12 as an intake pressure and outputs an electric signal corresponding to a detected value. A water temperature sensor 44 provided in the engine 1 detects a temperature of cooling water flowing inside the engine 1 as a cooling water temperature and outputs an electric signal corresponding to a detected value. A rotational speed sensor 45 provided in the engine 1 detects a rotation angular speed of a crank shaft (not shown) of the engine 1 as an engine rotational speed NE and outputs an electric signal corresponding to a detected value. An oxygen sensor 46 provided in the exhaust passage 4 detects an oxygen concentration in the exhaust air and outputs an electric signal corresponding to a detected value. In addition, the evaporated fuel treatment apparatus 30 of the present embodiment is provided in the purge passage 23 with a vapor concentration sensor 47 exclusively provided for detecting a concentration of the vapor (vapor concentration) Cvp that is purged from the purge passage 23 to the intake passage 3. The vapor concentration sensor 47 corresponds to one example of a member for detecting the concentration of the evaporated fuel in the present disclosure. Additionally, the evaporated fuel treatment apparatus 30 of the present embodiment is provided in the purge passage 23 with a vapor temperature sensor 48 exclusively provided for detecting a temperature of the vapor (vapor temperature) Tvp. The vapor temperature sensor 48 corresponds to one example of a member for detecting the temperature of the evaporated fuel in the present disclosure.

The evaporated fuel treatment apparatus 30 of the present embodiment is provided with an electronic control unit (ECU) 50 taking in charge of various control. The ECU 50 is input with various signals output from the various sensors and others 41 to 48. The ECU 50 controls the injector 8, the ignition device 9, the purge pump 24, and the purge valve 25 based on these input signals to carry out fuel injection control, ignition timing control, and purge control.

Furthermore, this hybrid vehicle 60 is provided with a driving motor (not shown) and a storage battery 61 to supply electric power to the motor. The ECU 50 is arranged to monitor a state of this storage battery 61 (a state of voltage and current).

Herein, the fuel injection control indicates controlling the injector 8 according to the operation state of the engine 1 to control a fuel injection amount and a fuel injection timing. The ignition timing control indicates controlling the ignition device 9 according to the operation state of the engine 1 to control an ignition timing of the combustible air-fuel mixture. The purge control indicates controlling the purge pump 24 and the purge valve 25 according to the operation state and others of the engine 1 to control a purge flow rate of the vapor that is to be purged from the canister 21 to the intake passage 3 via the purge passage 23.

In the present embodiment, the ECU 50 is provided with known configuration including a central processing unit (CPU), a read-only memory (ROM), a random-access memory (RAM), a back-up RAM, and others. The ROM stores in advance a predetermined control program related to the above-mentioned various control. The ECU (CPU) 50 is arranged to carry out the various control according to these control programs. The ECU 50 corresponds to one example of a control member in the present disclosure.

In the present embodiment, the ECU 50 is arranged to open the purge valve 25 and controls the purge pump 24 to be the predetermined rated rotational speed in order to purge a predetermined flow rate of the vapor to the intake passage 3 during steady operation of the engine 1. In the present embodiment, known contents of the fuel injection control and the injection timing control are to be adopted, and only the purge control will be explained in detail below.

For the purpose of reducing the manufacturing cost for the purge valve 25 and reducing energy required for operation of the purge valve 25, the evaporated fuel treatment apparatus 30 of the present embodiment needs to utilize inexpensive constituent components of the purge valve 25 and to reduce the supply power required for the solenoid 36 of the purge valve 25. For this purpose, the ECU 50 is made to carry out the following purge control in the present embodiment.

(Purge Control)

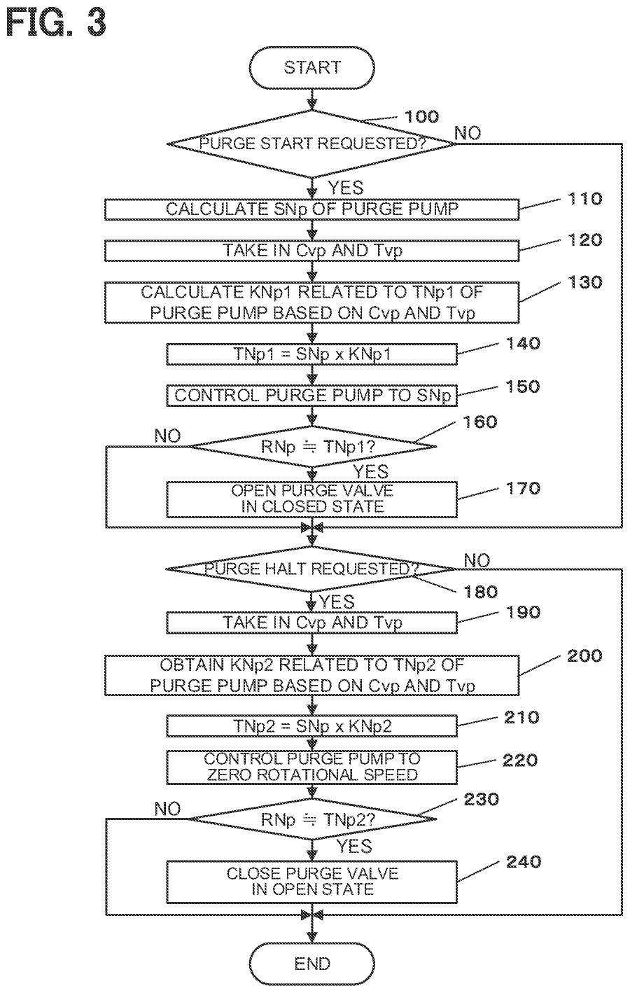

The purge control of the present embodiment is explained. FIG. 3 is a flowchart showing the control contents. The ECU 50 periodically carries out this routine per predetermined time.

When the process proceeds to this routine, in step 100, the ECU 50 determines whether purging start is requested. The ECU 50 is made to perform this determination based on the operation state and others of the engine 1. When this determination result is affirmative, the ECU 50 proceeds the process to step 110, and when the determination result is negative, the ECU 50 proceeds the process to step 180.

In step 110, the ECU 50 calculates a rated rotational speed SNp of the purge pump 24. The ECU 50 can calculate the rated rotational speed SNp based on the operation state and others of the engine 1.

Subsequently, in step 120, the ECU 50 takes in the vapor concentration Cvp and the vapor temperature Tvp based on the detected values detected by the vapor concentration sensor 47 and the vapor temperature sensor 48, respectively.

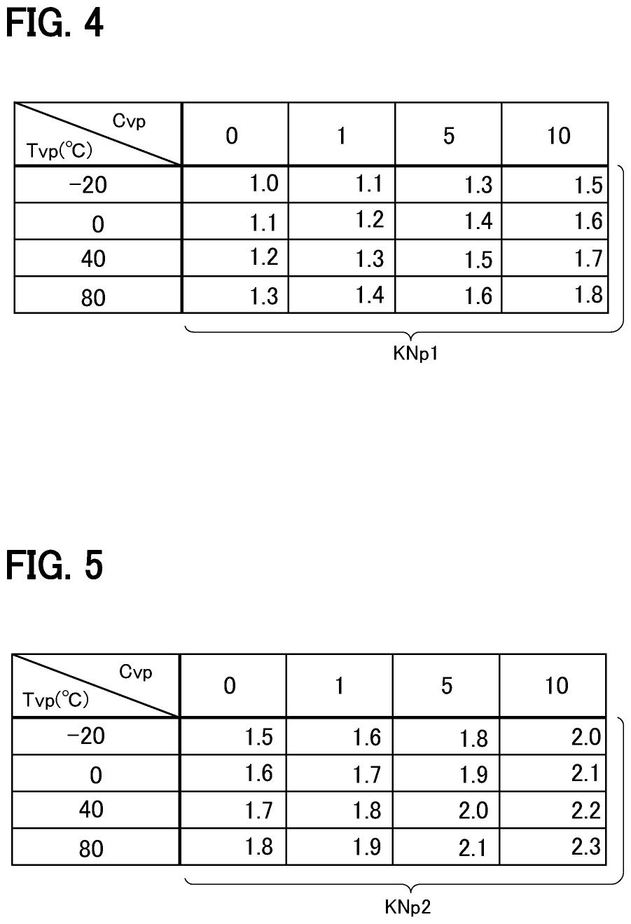

Subsequently, in step 130, the ECU 50 calculates a first correction coefficient KNp1 related to a first threshold rotational speed TNp1 of the purge pump 24 based on the vapor concentration Cvp and the vapor temperature Tvp. The ECU 50 can calculate the first correction coefficient KNp1 with respect to the vapor concentration Cvp and the vapor temperature Tvp by referring to a first correction coefficient map shown in FIG. 4 as one example.

Subsequently, in step 140, the ECU 50 calculates the first threshold rotational speed TNp1 by multiplying the rated rotational speed SNp with the first correction coefficient KNp1.

Subsequently, in step 150, the ECU 50 controls the purge pump 24 to be the rated rotational speed SNp.

Subsequently, in step 160, the ECU 50 determines whether an actual rotational speed RNp of the purge pump 24 is almost equal to the first threshold rotational speed TNp1. When this determination result is affirmative, the ECU 50 proceeds the process to step 170, and when the determination result is negative, the ECU 50 proceeds the process to step 180.

Then, in step 170, the ECU 50 opens the purge valve 25 in the valve-closed state.

Thereafter, in step 180 proceeded from step 100, step 160, or step 170, the ECU 50 determines whether there is a purge halt request. The ECU 50 is made to perform this determination based on the operation state and others of the engine 1. When this determination result is affirmative, the ECU 50 proceeds the process to step 190. When the determination result is negative, the ECU 50 once terminates the following processes.

In step 190, the ECU 50 takes in the vapor concentration Cvp and the vapor temperature Tvp based on the detected values of the vapor concentration sensor 47 and the vapor temperature sensor 48, respectively.

Subsequently, in step 200, the ECU 50 calculates a second correction coefficient KNp2 related to a second threshold rotational speed TNp2 of the purge pump 24 based on the vapor concentration Cvp and the vapor temperature Tvp. The ECU 50 can calculate the second correction coefficient KNp2 with respect to the vapor concentration Cvp and the vapor temperature Tvp by referring to a second correction coefficient map shown in FIG. 5 as one example. In this second correction coefficient map, the second correction coefficient KNp2 is set to be larger than a value of the first correction coefficient KNp1. This setting has been made to set the second threshold rotational speed TNp2 in closing the purge valve 25 to be higher than the first threshold rotational speed TNp1 in opening the purge valve 25, and further made to conform to the above-mentioned type of the purge valve 25 in which the valve element 34 is provided upstream of the valve seat 33 to be seated on the valve seat 33.

Subsequently, in step 210, the ECU 50 calculates the second threshold rotational speed TNp2 by multiplying the second correction coefficient KNp2 with the rated rotational speed SNp.

Subsequently, in step 220, the ECU 50 controls the purge pump 24 to the rotational speed of zero.

Subsequently, in step 230, the ECU 50 determines whether the actual rotational speed RNp of the purge pump 24 is almost equal to the second threshold rotational speed TNp2. When this determination result is affirmative, the ECU 50 proceeds the process to step 240, and when the determination result is negative, the processes thereafter are once terminated.

Then, in step 240, the ECU 50 closes the purge valve 25 in the valve-open state and once terminates the processes thereafter.

According to the above purge control, when the vapor is to be purged from the canister 21 to the intake passage 3, the ECU 50 opens the purge valve 25 and controls the purge pump 24 to be the predetermined rated rotational speed SNp. When the vapor purging is to be halted, the ECU 50 closes the purge valve 25 and controls the purge pump 24 to be the rotational speed of zero.

According to the above control, when the vapor starts to be purged upon a request of purging start, before opening the purge valve 25 from the valve-closed state, the ECU 50 is arranged to gradually control the purge pump 24 to be the rated rotational speed SNp from a rotational speed (rotational speed of zero in the present embodiment) lower than the rated rotational speed SNp, and then the ECU 50 is arranged to open the purge valve 25 when the purge pump 24 has reached the predetermined first threshold rotational speed TNp1 that is lower than the rated rotational speed SNp in the controlling process.

According to the above purge control, when purging of the vapor is to be halted, before closing the purge valve 25 from the valve-open state, the ECU 50 is arranged to gradually control the purge pump 24 from the rated rotational speed SNp to the rotational speed of zero, and then the ECU 50 is arranged to close the purge valve 25 when the purge pump 24 has reached the predetermined second threshold rotational speed TNp2 that is lower than the rated rotational speed SNp in the controlling process.

According to the above purge control, the ECU 50 is arranged to correct the first threshold rotational speed TNp1 and the second threshold rotational speed TNp2 based on the detected vapor concentration Cvp and the detected vapor temperature Tvp.

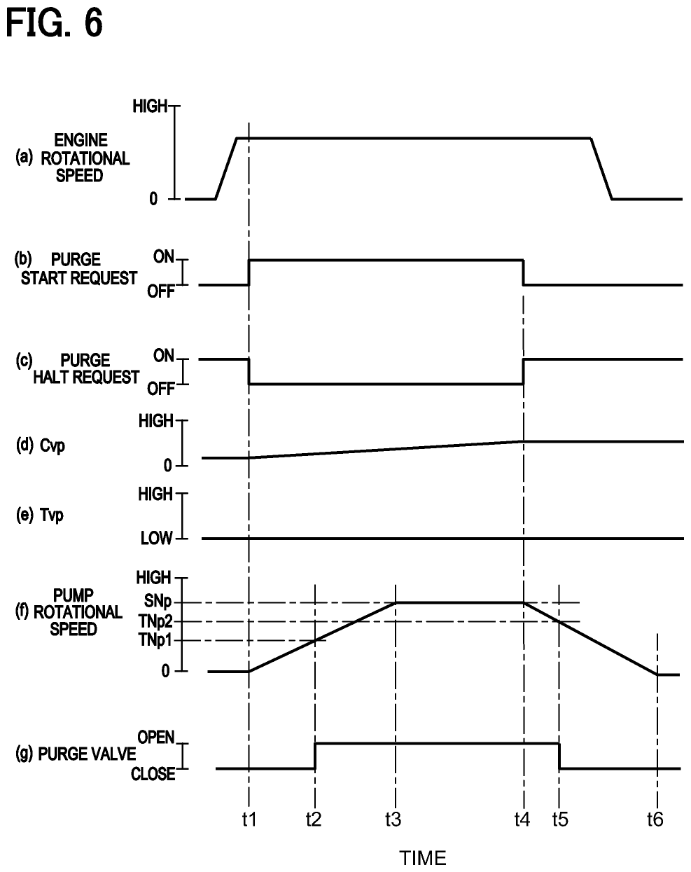

Herein, one example of behavior of various parameters in the above-mentioned purging control is shown in a time chart of FIG. 6. In FIG. 6, a graph indicated with an annotated sign (a) represents changes in an engine rotational speed, a graph (b) represents changes in a request of purging start, a graph (c) represents changes in a request of purging halt, a graph (d) represents changes in the vapor concentration Cvp, a graph (e) represents changes in the vapor temperature Tvp, a graph (f) represents changes in the rotational speed of the purge pump 24 (pump rotational speed), and a graph (g) represents changes in opening and closing of the purge valve 25, respectively.

In FIG. 6, when the engine rotational speed is increased in (a) at time t1, the purging start request is “ON” in (b), and the purging halt request is “OFF” in (c), the purge pump 24 is gradually controlled to the rated rotational speed SNp from the rotational speed of zero and the pump rotational speed starts to increase from “0” in (f).

Subsequently, when the pump rotational speed in (f) has reached the first threshold rotational speed TNp1 at time t2, the purge valve 25 in (g) is opened from the valve-closed state. Thereafter, when the pump rotational speed in (f) has reached the rated rotational speed SNp, that speed is kept at the rated rotational speed SNp.

Subsequently, when the purging start request in (b) is “OFF” and the purging halt request in (c) is “ON” at time t4, the purge pump 24 is gradually controlled to the rotational speed of zero from the rated rotational speed SNp and the pump rotational speed in (f) starts to decrease from the rated rotational speed SNp.

Subsequently, when the pump rotational speed in (f) has reached the second threshold rotational speed TNp2 that is higher than the first threshold rotational speed TNp1 at time t5, the purge valve 25 in (g) is closed from the valve-open state and the pump rotational speed in (f) reaches the rotational speed of zero at time t6.

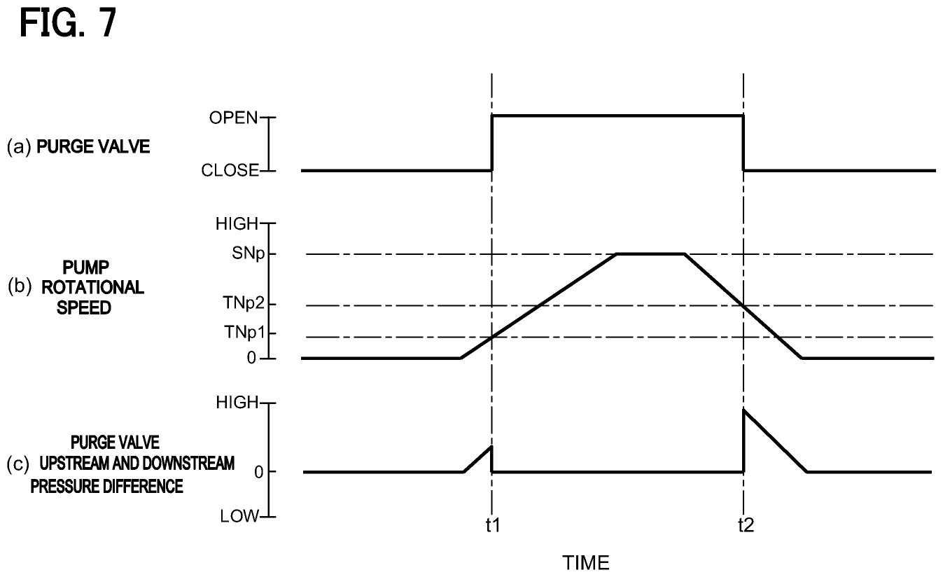

Further, FIG. 7 is a time chart showing one example of behavior of various parameters (especially, an upstream and downstream pressure difference of the purge valve 25) in the above purge control. In FIG. 7, a graph indicated with an annotated sign (a) represents changes in opening and closing of the purge valve 25, a graph (b) represents changes in the pump rotational speed, and a graph (c) represents changes in the upstream and downstream pressure difference of the purge valve 25, respectively. In FIG. 7, the upstream and downstream pressure difference of the purge valve 25 once increases directly before the pump rotational speed in (b) has reached the first threshold rotational speed TNp1 and the purge valve 25 in (a) is opened at time t1, and once increases directly after the pump rotational speed in (b) has reached the second threshold rotational speed TNp2 and the purge valve 25 is closed at time t2. In a state in which the purge valve 25 is closed or in which the purge valve 25 is opened other than the above timing, the upstream and downstream pressure difference is made to remain “zero”.

(Operations and Effects of Evaporated Fuel Treatment Apparatus)

According to the above-mentioned evaporated fuel treatment apparatus 30 of the present embodiment, when the vapor is purged from the canister 21 to the intake passage 3, the ECU 50 opens the purge valve 25 and controls the purge pump 24 to the predetermined rated rotational speed SNp, and when purging is to be halted, the ECU 50 closes the purge valve 25 and controls the purge pump 24 to the rotational speed of zero. Herein, when starting purging of the vapor, before opening the purge valve 25 from the valve-closed state, the ECU 50 gradually controls the purge pump 24 to the rated rotational speed SNp from the rotational speed of zero that is lower than the rated rotational speed SNp, and when the purge pump 24 has reached the predetermined first threshold rotational speed TNp1 lower than the rated rotational speed SNp in that controlling process, the ECU 50 opens the purge valve 25. Accordingly, the purge valve 25 is opened when the purge pump 24 has reached the first threshold rotational speed TNp1 lower than the rated rotational speed SNp in the process of gradually controlling the purge pump 24 to the rated rotational speed, so that it is possible to suppress the shut-off force of the purge valve 25 or the force of opening the purge valve 25 from the valve-closed state to the amount enough to oppose to the pressure lower than the discharge pressure of the purge pump 24 at the time when the purge pump 24 has reached the rated rotational speed SNp. Therefore, the shut-off force of the purge valve 25 or the force of opening the purge valve 25 from the valve-closed state can be set relatively small, thus achieving reduction in manufacturing cost for the purge valve 25 and reduction in energy required for operating the purge valve 25.

For example, it is assumed that a purge valve of a similar type with the present embodiment is controlled to open when the purge pump has reached the rated rotational speed. In this case, during valve-opening of the purge valve, the pressure of the vapor discharged out of the purge pump becomes maximum to act on the valve element of the purge valve in a direction to be seated on the valve seat. Therefore, the solenoid needs to generate a relatively large suction force in order to separate the valve element away from the valve seat against this pressure. However, in the present embodiment, the purge valve 25 is opened when the purge pump 24 has reached the first threshold rotational speed TNp1 that is lower than the rated rotational speed SNp, and accordingly, the upstream and downstream pressure difference of the purge valve 25 at that time is relatively small, so that the solenoid only has to generate a relatively small suction force. In that sense, the solenoid 36 can adopt inexpensive solenoid (such as a solenoid with less winding numbers of wire coil), so that the electric power to be supplied to the solenoid 36 can also be reduced. Thus, the manufacturing cost for the purge valve 25 and the energy required for operating the purge valve 25 can be reduced.

According to the configuration of the present embodiment, when purging of the vapor is to be halted, before closing the purge valve 25 from the valve-open state, the ECU 50 gradually controls the purge pump 24 to the rotational speed of zero from the rated rotational speed SNp, and when the purge pump 24 has reached the predetermined second threshold rotational speed TNp2 lower than the rated rotational speed SNp in the control process, the ECU 50 closes the purge valve 25. Accordingly, the purge valve 25 is closed when the purge pump 24 has reached the second threshold rotational speed TNp2 lower than the rated rotational speed SNp in the process of gradually controlling the purge pump 24 to the rotational speed of zero from the rated rotational speed SNp, so that it is possible to suppress the force of closing the purge valve 25 from the valve-open state to the amount enough to oppose to the pressure lower than the discharge pressure at the time when the purge pump 24 has reached the rated rotational speed SNp. Therefore, the force of closing the purge valve 25 from the valve-open state can be set relatively small, thereby reducing the manufacturing cost for the purge valve 25 and the energy required for operating the purge valve 25. This reduction in the manufacturing cost and the energy required for operation of the purge valve 25 can be achieved because inexpensive solenoid for the solenoid 36 can be adopted and the electric power to be supplied to the solenoid 36 can be reduced.

According to the configuration of the present embodiment, the purge valve 25 is a type configured such that the valve element 34 is provided upstream of the valve seat 33 to be seated on the valve seat 33. In this type of the purge valve, in the valve-closed state in which the valve element 34 is seated on the valve seat 33, both the pressure of the vapor and the urging force of the spring 35 are applied in a direction (in a valve-closing direction) in which the valve element 34 is seated on the valve seat 33. Accordingly, in opening the purge valve 25, the valve element 34 is driven by the solenoid 36 to be separated from the valve seat 33 when the purge pump 24 has reached the first threshold rotational speed TNp1 that is lower than the rated rotational speed SNp, and thus the driving force of the solenoid 36 required for valve opening becomes relatively small. In that sense, too, the shut-off force of the purge valve 25 or the force of opening the purge valve 25 from the valve-closed state can be made relatively small, thereby reducing the manufacturing cost for the purge valve 25 and the energy required for operating the purge valve 25. Further, the second threshold rotational speed TNp2 related to valve closing of the purge valve 25 is set higher than the first threshold rotational speed TNp1 related to valve opening, so that the solenoid 36 can be operated earlier by that difference when the purge valve 25 is to be closed. In that sense, too, the energy required for operating the purge valve 25 can further be reduced.

According to the configuration of the present embodiment, both the first threshold rotational speed TNp1 and the second threshold rotational speed TNp2 are corrected based on the detected vapor concentration Cvp and the detected vapor temperature Tvp, and thus the first threshold rotational speed TNp1 and the second threshold rotational speed TNp2 can be preferably corrected according to the properties of the vapor. Therefore, the timing of opening and closing the purge valve 25 can be accurately controlled according to the properties of the vapor.

According to the configuration of the present embodiment, the purge pump 24 is gradually controlled to the rated rotational speed SNp upon request of purging start, and when the purge pump 24 has reached the first threshold rotational speed TNp1 in the control process, the purge valve 25 is opened. Accordingly, by the time when the purge pump 24 has reached the rated rotational speed SNp irrespective of establishment of any purging preconditions, the necessary and enough vapor is to be purged to the intake passage 3. Therefore, irrespective of establishment of the purging preconditions, the vapor can be appropriately purged to the intake passage 3.

### Second Embodiment

Next, a second embodiment embodying an evaporated fuel treatment apparatus will be explained in detail with reference to the accompanying drawings.

In the present embodiment, similar or identical parts or components to those of the first embodiment are assigned with the same reference signs as those in the first embodiment and their explanations are omitted, and thus, the following explanation is made with a focus on the differences from the first embodiment. The present embodiment is different from the first embodiment in the contents of purge control.

(Purge Control)

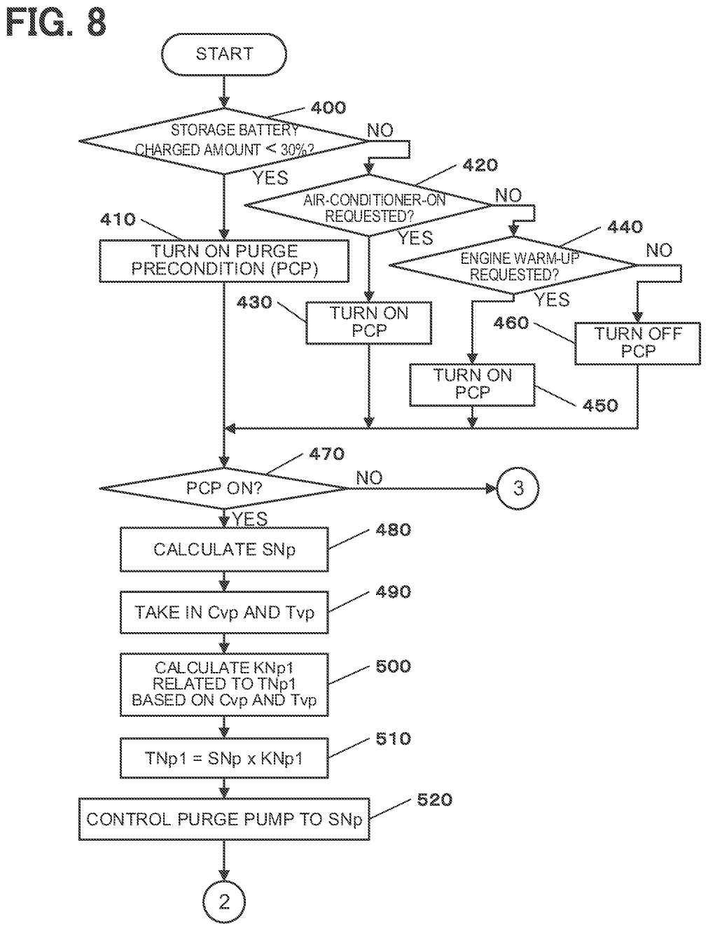

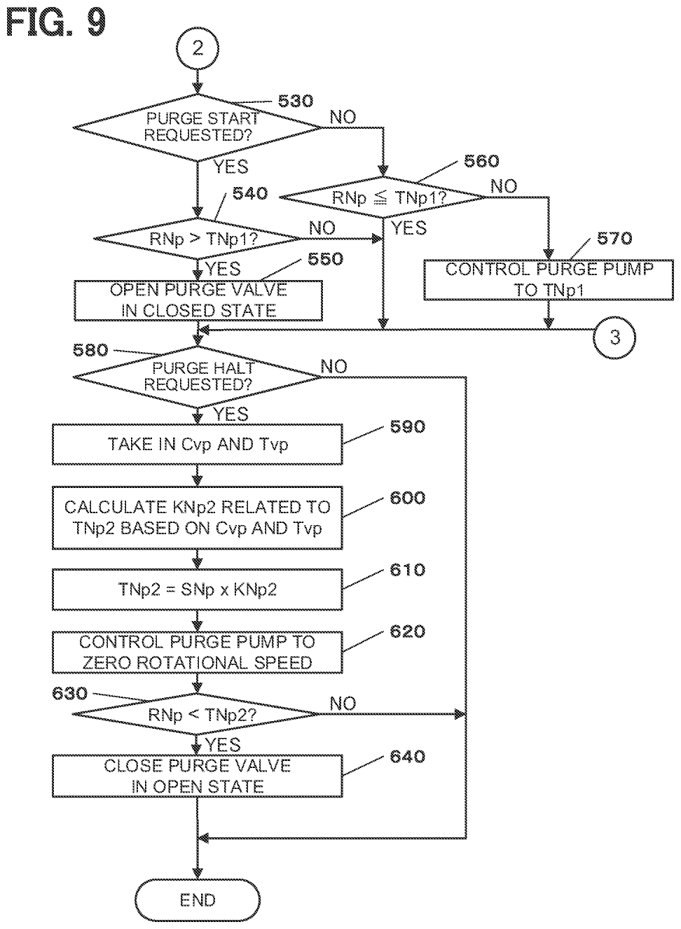

A purge control of the present embodiment is now explained. The control contents are illustrated in flow charts of FIG. 8 and FIG. 9. The ECU 50 periodically carries out this routine per predetermined time.

When the process proceeds to this routine, in step 400, the ECU 50 determines whether a charged amount of the storage battery 61 is less than “30%”. The “30%” is just one example, and it indicates a ratio to the full charge (100%). When this determination result is affirmative, the ECU 50 proceeds the process to step 410, and when the determination result is negative, the ECU 50 proceeds the process to step S420.

In step 410, the ECU turns “ON” a purge precondition PCP. Namely, the ECU 50 determines establishment of the purge precondition. Thereafter, the ECU 50 proceeds the process to step 470.

On the other hand, in step 420, the ECU 50 determines whether there is a request of turning on an air conditioner. Specifically, the ECU 50 determines whether there is a request of turning on the air conditioner mounted on a hybrid vehicle. When this determination result is affirmative, the ECU 50 proceeds the process to step 430, and when the determination result is negative, the ECU 50 proceeds the process to step 440.

In step 430, the ECU 50 turns “ON” the purge precondition and proceeds the process to step 470.

On the other hand, in step 440, the ECU 50 determines whether warming-up of the engine is requested. Namely, the ECU 50 determines whether there is a request for warming up the engine 1. When this determination result is affirmative, the ECU 50 proceeds the process to step 450, and when the determination result is negative, the ECU 50 proceeds the process to step 460.

In step 450, the ECU 50 turns “ON” the purge precondition PCP and proceeds the process to step 470.

On the other hand, in step 460, the ECU turns “OFF” the purge precondition. Specifically, the ECU 50 determines failure of establishment of the purge precondition. Then, the ECU 50 proceeds the process to step 470.

In step 470 proceeded from step 410, 430, 450, or 460, the ECU 50 determines whether the purge precondition PCP is “ON”. When this determination result is affirmative, the ECU 50 proceeds the process to step 480, and when the determination result is negative, the ECU 50 proceeds the process to step S80. In the present embodiment, the purge precondition PCP is turned “ON” when any one of conditions that the storage battery charged amount is less than 30%, the air conditioner is requested to be turned on, and the engine is requested to be warmed up is established.

In step 480, the ECU 50 calculates the rated rotational speed SNp of the purge pump 24. The ECU 50 can calculate the rated rotational speed SNp based on the operation state and others of the engine 1.

Subsequently, in step 490, the ECU 50 takes in the vapor concentration Cvp and the vapor temperature Tvp based on the detected values of the vapor concentration sensor 47 and the vapor temperature sensor 48, respectively.

Subsequently, in step S00, the ECU 50 calculates the first correction coefficient KNp1 related to the first threshold rotational speed Np1 of the purge pump 24 based on the vapor concentration Cvp and the vapor temperature Tvp. The ECU 50 can calculate the first correction coefficient KNp1 with respect to the vapor concentration Cvp and the vapor temperature Tvp by referring to the first correction coefficient map shown in FIG. 4 as one example.

Subsequently, in step S10, the ECU 50 calculates the first threshold rotational speed TNp1 by multiplying the first correction coefficient KNp1 with the rated rotational speed SNp.

Subsequently, in step S20, the ECU 50 controls the purge pump 24 to be the rated rotational speed SNp.

Subsequently, in step S30, the ECU 50 determines whether the purging start is requested. The ECU 50 is made to carry out this determination based on the operation state and others of the engine 1. When this determination result is affirmative, the ECU 50 proceeds the process to step S40, and when the determination result is negative, the ECU 50 proceeds the process to step S60.

In step S40, the ECU 50 determines whether the actual rotational speed RNp of the purge pump 24 is larger than the first threshold rotational speed TNp1. When this determination result is affirmative, the ECU 50 proceeds the process to step S50, and when the determination result is negative, the ECU 50 proceeds the process to step S80.

Subsequently, in step S50, the ECU 50 opens the purge valve 25 in the valve-closed state and proceeds the process to step S80. Namely, in the present embodiment, the purge valve 25 in the valve-closed state is to be opened when the purging start has been requested and the actual rotational speed RNp of the purge pump 24 is larger than the first threshold rotational speed TNp1.

On the other hand, in step S60, the ECU 50 determines whether the actual rotational speed RNp of the purge pump 24 is equal to or less than the first threshold rotational speed TNp1. When this determination result is affirmative, the ECU 50 proceeds the process to step S80, and when the determination result is negative, the ECU 50 proceeds the process to step S70.

In step S70, the ECU 50 controls the purge pump 24 to the first threshold rotational speed TNp1 and proceeds the process to step S80.

In step S80 proceeded from step S40, 550, 560, or 570, the ECU 50 determines whether there is a request for purging halt. The ECU 50 is arranged to make this determination based on the operation state and others of the engine 1. When this determination result is affirmative, the ECU 50 proceeds the process to step S90, and when the determination result is negative, the ECU 50 once terminates the processes thereafter.

In step S90, the ECU 50 takes in the vapor concentration Cvp and the vapor temperature Tvp based on the detected values of the vapor concentration sensor 47 and the vapor temperature sensor 48, respectively.

Subsequently, in step 600, the ECU 50 calculates the second correction coefficient KNp2 related to the second threshold rotational speed TNp2 of the purge pump 24 based on the vapor concentration Cvp and the vapor temperature Tvp. The ECU 50 can calculate the second correction coefficient KNp2 with respect to the vapor concentration Cvp and the vapor temperature Tvp by referring to the second correction coefficient map shown in FIG. 5 as one example.

Subsequently, in step 610, the ECU 50 calculates the second threshold rotational speed TNp2 by multiplying the second correction coefficient KNp2 with the rated rotational speed SNp.

Subsequently, in step 620, the ECU 50 controls the purge pump 24 to the rotational speed of zero.

Subsequently, in step 630, the ECU 50 determines whether the actual rotational speed RNp of the purge pump 24 is smaller than the second threshold rotational speed TNp2. When this determination result is affirmative, the ECU 50 proceeds the process to step 640, and when the determination result is negative, the ECU 50 once terminates the following processes.

Then, in step 640, the ECU 50 closes the purge valve 25 in the valve-open state and once terminates the following processes.

According to the above purge control, when the purging is to be started, before opening the purge valve 25 from the valve-closed state, the ECU 50 is arranged to gradually control the purge pump 24 to the rated rotational speed SNp from the rotational speed (in the present embodiment, “the rotational speed of zero”) lower than the rated rotational speed SNp when the predetermined purging precondition is established, and the ECU 50 is further arranged to open the purge valve 25 when the purge pump 24 has reached the first threshold rotational speed TNp1 in the control process and the purging start is requested, which are especially different from the first embodiment.

(Operations and Effects of Evaporated Fuel Treatment Apparatus)

According to the configuration of the evaporated fuel treatment apparatus 30 of the present embodiment as mentioned above, the purge pump 24 is gradually controlled to the rated rotational speed SNp when the predetermined purging precondition is established, and the purge valve 25 is opened when the purge pump 24 has reached the first threshold rotational speed TNp1 in the control process and the purging start is requested. Accordingly, when the purging precondition is established, the purge pump 24 starts to be gradually controlled even if there is no request of purging start, and therefore, when there is a request of purging start, the purge valve 25 is opened to purge the vapor early to the intake passage 3. Therefore, it is possible to improve the responsivity of purging in response to the purging start request.

According to the configuration of the present embodiment, when the purging start is requested and the actual rotational speed RNp of the purge pump 24 is larger than the first threshold rotational speed TNp1, the purge valve 25 in the valve-closed state is made to be opened. Accordingly, it is possible to prevent the purge valve 25 from being unintentionally opened or closed.

### Third Embodiment

Next, a third embodiment embodying an evaporated fuel treatment apparatus is explained in detail with reference to the accompanying drawings.

The present embodiment is mainly different in its configuration of the purge valve 25 from the above-mentioned respective embodiments, and in accordance with the differences, contents of the purge control is also different from those in the above-mentioned embodiments.

(Configuration of Purge Valve)

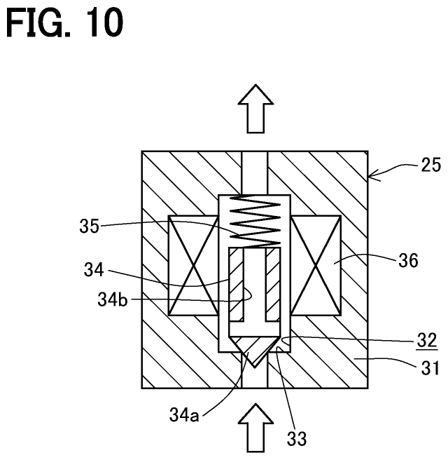

In this embodiment, too, the purge valve 25 is constituted of a normally-closed electromagnetic open-close valve (shut-off valve) and configured to open and close in order to release or shut off the purge passage 23. FIG. 10 is a sectional view of one example of the purge valve 25 in the present embodiment. As shown in FIG. 10, this purge valve 25 is provided with the constituent components as similar to the above-mentioned respective embodiments, but the present embodiment is different from the above-mentioned respective embodiments in an arrangement of the valve element 34 and the spring 35 and the configuration that the valve element 34 is provided in the passage 32 downstream of the valve seat 33 to be seated on the valve seat 33.

During non-excitation (off) of the solenoid 36, this purge valve 25 is urged in a direction in which the valve element 34 is seated on the valve seat 33 by the spring 35 to close as shown in FIG. 10. On the other hand, by the excitation of the solenoid 36 from the valve-closed state shown in FIG. 10, in the purge valve 25, the valve element 34 is moved upward to open against the urging force of the spring 35. This purge valve 25 is subjected to the pressure of the vapor with respect to the valve element 34 from the upstream side of the passage 32, and accordingly, the pressure of the vapor is applied to the valve element 34 in a direction to separate the valve element 34 away from the valve seat 33 (in a direction to open the valve) against the urging force of the spring 35 during operation of the purge pump 24. Further, while the purge pump 24 is not operated, the urging force of the spring 35 is applied to the valve element 34 in a direction to bring the valve element 34 to be seated on the valve seat 33 (valve closing). Accordingly, in order to open the purge valve 25 while the purge pump 24 is operated, the solenoid 36 needs to generate an electromagnetic force large enough to overthrow the difference of the vapor pressure and the urging force of the spring 35.

(Purge Control)

In the present embodiment, the purge control similar to that of the first embodiment is to be implemented with some exceptions in its configuration. The differences are about settings of the first threshold rotational speed TNp1 and the second threshold rotational speed TNp2. In the present embodiment, the second threshold rotational speed TNp2 is set to be equal to the first threshold rotational speed TNp1.

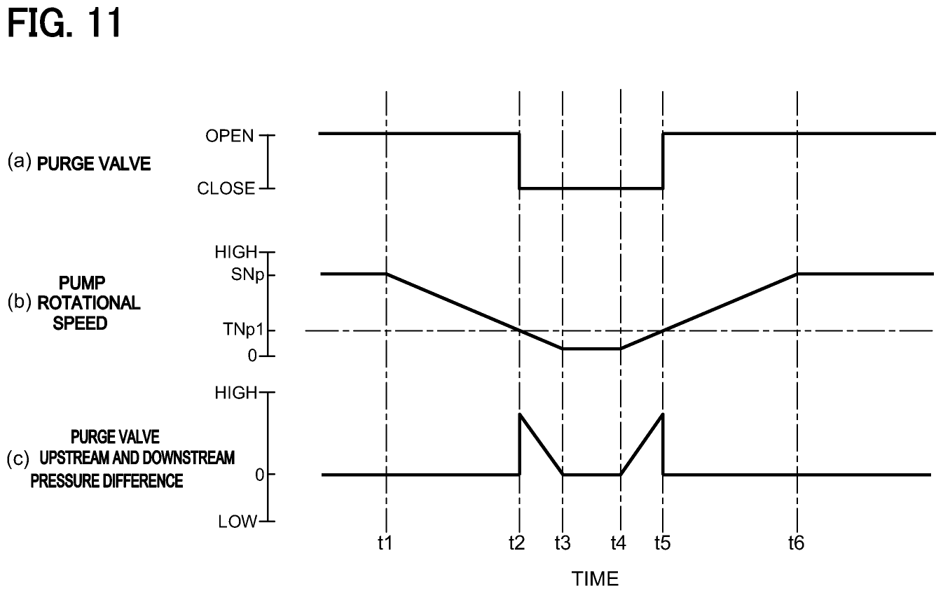

FIG. 11 is a time chart exemplifying one example of behavior of various parameters (especially an upstream and downstream pressure difference of the purge valve 25) in the above purge control. In FIG. 11, a graph indicated with an annotated sign (a) represents changes in opening and closing of the purge valve 25, a graph (b) represents changes in a pump rotational speed, and a graph (c) represents changes in the upstream and downstream pressure difference of the purge valve 25, respectively. In FIG. 11, the upstream and downstream pressure difference of the purge valve 25 in (c) once increases at time t2 when the pump rotational speed in (b) has reached the first threshold rotational speed TNp1 and the purge valve 25 in (a) is closed and at time t5 when the pump rotational speed in (b) has reached the first threshold rotational speed TNp1 and the purge valve 25 in (a) is opened. In any states in which the purge valve 25 is closed or opened other than the above states, the upstream and downstream pressure difference is made to be kept “0”.

(Operations and Effects of Evaporated Fuel Treatment Apparatus)

According to the configuration of the present embodiment, the purge valve 25 is a type in which the valve element 34 is provided downstream of the valve seat 33 to be seated on the valve seat 33. In this type of the purge valve 25, only the urging force of the spring 35 is applied to the valve element 34 in a direction (the valve-closing direction) to be seated on the valve seat 33 in the valve-closed state in which the valve element 34 is seated on the valve seat 33, and the pressure of the vapor is applied to the valve element 34 in a direction to be separated away from the valve seat 33. Accordingly, when opening the purge valve 25, the valve element 34 is driven by the solenoid 36 to be separated away from the valve seat 33 when the purge pump 24 has reached the first threshold rotational speed TNp1 that is lower than the rated rotational speed SNp. Therefore, the urging force of the spring 35 that has been acting on the valve element 34 to be seated on the valve seat 33 against the pressure of the vapor can be set relatively small. In that sense, too, an inexpensive spring can be adopted as the spring 35, thus achieving reduction in the manufacturing cost for the purge valve 25. Further, there becomes less influence of changes over time of the spring 35 relative to the driving force of the solenoid 36, and thus the purge valve 25 is free from valve-opening at unintentional timing and free from being kept open. In that sense, valve-opening of the purge valve 25 can be accurately controlled.

The present disclosure is not limited to the above-mentioned embodiments, and may be embodied with partly changing its configuration in an appropriate manner without departing from the scope of the disclosure.

(1) In the above-mentioned respective embodiments, when purging of the vapor is to be started, the purge pump 24 is configured to be gradually controlled to the rated rotational speed SNp form the “rotational speed of zero” which is lower than the rated rotational speed SNp before opening the purge valve 25 from the valve-closed state. Alternatively, when the purge pump is configured to be controlled to a predetermined idle rotational speed at the same time with starting operation of the engine 1, the purge pump may be configured to be gradually controlled to the rated rotational speed SNp from the “idle rotational speed” which is lower than the rated rotational speed SNp before opening the purge valve from the valve-closed state.

(2) In the above-mentioned embodiments, the vapor concentration sensor 47 to directly detect the vapor concentration Cvp is provided as a member for detecting the concentration of the evaporated fuel. Alternatively, the intake pressure sensor, the air flow meter, and the ECU may be provided as members for detecting the concentration of the evaporated fuel to indirectly detect the vapor concentration. Namely, the ECU calculates changes in the intake amount between the intake amount detected by the air flow meter when the vapor is not purged in the intake passage and the intake amount detected by the air flow meter when the vapor is purged in the intake passage, and further calculates an estimated purge flow rate of the vapor based on a valve open degree of the purge valve during valve-opening and the intake pressure detected by the intake pressure sensor at that time. Then, the ECU calculates a density difference of the vapor based on these changes in the intake amount and the estimated purge flow rate to further calculate the vapor concentration based on that density difference.

(3) In the above-mentioned embodiments, the purge valve 25 is constituted of an open-close valve (shut-off valve) which is movable only at two positions of valve opening (full open) and valve closing (full close), but alternatively, the purge valve may be configured with a motor-operated valve in which the purge valve can be changed its open degree.

(4) In the above-mentioned embodiments, the present invention is embodied as an engine system with no supercharger provided, but alternatively, the invention may be embodied in an engine system provided with a supercharger. In this case, an outlet of the purge passage may be connected to the intake passage upstream of a compressor of the supercharger.

### INDUSTRIAL APPLICABILITY

The present disclosure can be utilized for a vehicle mounted only with an engine and a hybrid vehicle mounted with an engine and a motor.

### REFERENCE SIGNS LIST

1 Engine

3 Intake passage

5 Fuel tank

21 Canister

23 Purge passage

24 Purge pump

25 Purge valve

30 Evaporated fuel treatment apparatus

32 Passage

33 Valve seat

34 Valve element

35 Spring

36 Solenoid (Driving member)

47 Vapor concentration sensor (Member of detecting a concentration of evaporated fuel)

48 Vapor temperature sensor (Member of detecting a temperature of evaporated fuel)

50 ECU (Control member)

1. An evaporated fuel treatment apparatus comprising:
a canister to collect evaporated fuel generated in a fuel tank;
a purge passage to introduce and purge the evaporated fuel collected in the canister to an intake passage of an engine;
a purge pump provided in the purge passage to pressure-feed the evaporated fuel collected in the canister to the intake passage, the purge pump being configured to control a discharge pressure of the evaporated fuel according to a rotational speed of the purge pump;
a purge valve provided in the purge passage downstream of the purge pump to open and close the purge passage; and
a control member to control the purge pump and the purge valve, the control member being configured to control the purge valve to open and the purge pump to be a predetermined rated rotational speed when the evaporated fuel is purged from the canister to the intake passage and to control the purge valve to close and the purge pump to be a rotational speed of zero when purging of the evaporated fuel is to be halted,
wherein,
when starting purging the evaporated fuel, the control member gradually controls the purge pump from a rotational speed lower than the rated rotational speed to the rated rotational speed before opening the purge valve from a valve-closed state and opens the purge valve in a process of the control when the purge pump has reached a predetermined first threshold rotational speed that is lower than the rated rotational speed.

2. The evaporated fuel treatment apparatus according to claim 1, wherein, when purging of the evaporated fuel is to be halted, the control member gradually controls the purge pump to be the rotational speed of zero from the rated rotational speed before closing the purge valve from a valve-open state and to close the purge valve when the purge pump has reached a predetermined second threshold rotational speed that is lower than the rated rotational speed in the process of the control.

3. The evaporated fuel treatment apparatus according to claim 2, wherein
the purge valve includes: a passage in which the evaporated fuel flows; a valve seat provided in the passage; a valve element provided upstream of the valve seat and allowed to be seated on the valve seat; a spring to urge the valve element in a direction to be seated on the valve seat; and a driving member to drive the valve element, and
the second threshold rotational speed is set higher than the first threshold rotational speed.

4. The evaporated fuel treatment apparatus according to claim 2, wherein
the purge valve includes: a passage in which the evaporated fuel flows;
a valve seat provided in the passage; a valve element provided downstream of the valve seat and allowed to be seated on the valve seat; a spring to urge the valve element in a direction to be seated on the valve seat; and a driving member to drive the valve element, and
the second threshold rotational speed is set equal to the first threshold rotational speed.

5. The evaporated fuel treatment apparatus according to claim 1, wherein
the evaporated fuel treatment apparatus further comprises a member of detecting a concentration of the evaporated fuel and a member of detecting a temperature of the evaporated fuel, and
the control member is configured to correct the first threshold rotational speed based on a detected concentration and a detected temperature of the evaporated fuel.

6. The evaporated fuel treatment apparatus according to claim 1, wherein,
when starting purging of the evaporated fuel, during a request of purging start being made, the control member gradually controls the purge pump to the rated rotational speed from the rotational speed lower than the rated rotational speed to the rated rotational speed before opening the purge valve from the valve-closed state and during the purge pump having reached the first threshold rotational speed in the process of the control, the control member opens the purge valve.

7. The evaporated fuel treatment apparatus according to claim 1 wherein, when starting purging of the evaporated fuel, during a predetermined purging precondition being established and before opening the purge valve from the valve-closed state, the control member gradually controls the purge pump to the rated rotational speed from the rotational speed lower than the rated rotational speed before opening the purge valve from the valve-closed state and during the purge pump having reached the first threshold rotational speed and a request of purging start being made in the process of the control, the control member opens the purge valve.

8. The evaporated fuel treatment apparatus according to claim 2, wherein
the evaporated fuel treatment apparatus further comprises a member of detecting a concentration of the evaporated fuel and a member of detecting a temperature of the evaporated fuel, and
the control member is configured to correct at least any one of the first threshold rotational speed and the second threshold rotational speed based on a detected concentration and a detected temperature of the evaporated fuel.

9. The evaporated fuel treatment apparatus according to claim 3, wherein
the evaporated fuel treatment apparatus further comprises a member of detecting a concentration of the evaporated fuel and a member of detecting a temperature of the evaporated fuel, and
the control member is configured to correct at least any one of the first threshold rotational speed and the second threshold rotational speed based on a detected concentration and a detected temperature of the evaporated fuel.

10. The evaporated fuel treatment apparatus according to claim 4, wherein
the evaporated fuel treatment apparatus further comprises a member of detecting a concentration of the evaporated fuel and a member of detecting a temperature of the evaporated fuel, and
the control member is configured to correct at least any one of the first threshold rotational speed and the second threshold rotational speed based on a detected concentration and a detected temperature of the evaporated fuel.

11. The evaporated fuel treatment apparatus according to claim 2, wherein, when starting purging of the evaporated fuel, during a request of purging start being made, the control member gradually controls the purge pump to the rated rotational speed from the rotational speed lower than the rated rotational speed to the rated rotational speed before opening the purge valve from the valve-closed state and during the purge pump having reached the first threshold rotational speed in the process of the control, the control member opens the purge valve.

12. The evaporated fuel treatment apparatus according to claim 3, wherein, when starting purging of the evaporated fuel, during a request of purging start being made, the control member gradually controls the purge pump to the rated rotational speed from the rotational speed lower than the rated rotational speed to the rated rotational speed before opening the purge valve from the valve-closed state and during the purge pump having reached the first threshold rotational speed in the process of the control, the control member opens the purge valve.

13. The evaporated fuel treatment apparatus according to claim 4, wherein, when starting purging of the evaporated fuel, during a request of purging start being made, the control member gradually controls the purge pump to the rated rotational speed from the rotational speed lower than the rated rotational speed to the rated rotational speed before opening the purge valve from the valve-closed state and during the purge pump having reached the first threshold rotational speed in the process of the control, the control member opens the purge valve.

14. The evaporated fuel treatment apparatus according to claim 5, wherein, when starting purging of the evaporated fuel, during a request of purging start being made, the control member gradually controls the purge pump to the rated rotational speed from the rotational speed lower than the rated rotational speed to the rated rotational speed before opening the purge valve from the valve-closed state and during the purge pump having reached the first threshold rotational speed in the process of the control, the control member opens the purge valve.

15. The evaporated fuel treatment apparatus according to claim 8, wherein, when starting purging of the evaporated fuel, during a request of purging start being made, the control member gradually controls the purge pump to the rated rotational speed from the rotational speed lower than the rated rotational speed to the rated rotational speed before opening the purge valve from the valve-closed state and during the purge pump having reached the first threshold rotational speed in the process of the control, the control member opens the purge valve.

16. The evaporated fuel treatment apparatus according to claim 2, wherein, when starting purging of the evaporated fuel, during a predetermined purging precondition being established and before opening the purge valve from the valve-closed state, the control member gradually controls the purge pump to the rated rotational speed from the rotational speed lower than the rated rotational speed before opening the purge valve from the valve-closed state and during the purge pump having reached the first threshold rotational speed and a request of purging start being made in the process of the control, the control member opens the purge valve.

17. The evaporated fuel treatment apparatus according to claim 3, wherein, when starting purging of the evaporated fuel, during a predetermined purging precondition being established and before opening the purge valve from the valve-closed state, the control member gradually controls the purge pump to the rated rotational speed from the rotational speed lower than the rated rotational speed before opening the purge valve from the valve-closed state and during the purge pump having reached the first threshold rotational speed and a request of purging start being made in the process of the control, the control member opens the purge valve.

18. The evaporated fuel treatment apparatus according to claim 4, wherein, when starting purging of the evaporated fuel, during a predetermined purging precondition being established and before opening the purge valve from the valve-closed state, the control member gradually controls the purge pump to the rated rotational speed from the rotational speed lower than the rated rotational speed before opening the purge valve from the valve-closed state and during the purge pump having reached the first threshold rotational speed and a request of purging start being made in the process of the control, the control member opens the purge valve.

19. The evaporated fuel treatment apparatus according to claim 5, wherein, when starting purging of the evaporated fuel, during a predetermined purging precondition being established and before opening the purge valve from the valve-closed state, the control member gradually controls the purge pump to the rated rotational speed from the rotational speed lower than the rated rotational speed before opening the purge valve from the valve-closed state and during the purge pump having reached the first threshold rotational speed and a request of purging start being made in the process of the control, the control member opens the purge valve.

20. The evaporated fuel treatment apparatus according to claim 8, wherein, when starting purging of the evaporated fuel, during a predetermined purging precondition being established and before opening the purge valve from the valve-closed state, the control member gradually controls the purge pump to the rated rotational speed from the rotational speed lower than the rated rotational speed before opening the purge valve from the valve-closed state and during the purge pump having reached the first threshold rotational speed and a request of purging start being made in the process of the control, the control member opens the purge valve.
